(19) United States
(12) Patent Application Publication
(10) Pub. No.: US 2004/0254288 A1
(43) Pub. Date: Dec. 16, 2004

(54) Method for fabricating polymer environmentally-friendly resin

(76) Inventor: Su-Tuan Hsu Tang, Tao Yuan City (TW)

Correspondence Address: TROXELL LAW OFFICE PLLC, SUITE 1404, 5205 LEESBURG PIKE, FALLS CHURCH, VA, 22041, US

(21) Appl. No.: 10/458,219

(22) Filed: Jun. 11, 2003

(51) Int. Cl. C08J 3/00

(52) U.S. Cl. 524/551

(57) ABSTRACT

The method disclosed by the present invention includes the following steps. First, liquid-phased acetic tri butyl citrite is combined with liquid-phased stabilizer to get the first mixture. Secondly, powder-like poly vinyl chloride, filling agent, light stabilizer uvasorb and fireproof agent are combined together to get the second mixture. Third, the first mixture and the second mixture are combined, and stirred under the room temperature. Finally, a cream-like finished product is gotten.

Then, the cream-like finished product is baked at the temperature of about 170° C. and thus solid-stated polymer environmental-friendly resin (PER) can be available.

### BACKGROUND OF THE INVENTION

1. Field of the Invention

The present invention relates to a method for fabricating polymer environmental-friendly resin (PER), which provides environmental protection and the same effect as conventional PVC.

2. Description of the Prior Art

Generally, environmental protection is defined as meeting the following requirements.

1. being disposable, biodegradable and can decompose into the earth without pollution, such as paper;

2. being recyclable, reproducible and reusable, such as PE, PP and so on; and

3. after being used, can be degraded by burning meanwhile without generation of toxic gas, and the resulting ash can be absorbed by the ground.

However, at present, the most widely-used PVC, a kind of non-pollution plastic, does not meet the above requirements. Besides, it is necessary to add acetic tri butyl citrite, such as DOP or DINP, into PVC to fabricate a variety of products. No matter DOP or DINP, after being combined with PVC, will emit Polychlorinated Biphenyls due to burning, exposure to sunlight or other reasons. Further, it is hard to decompose the combination of PVC and acetic tri butyl citrite, such as DOP or DINP unless burning or incineration. However, the combination of PVC and acetic tri butyl citrite almost does not degrade until the temperature of 1200° C. As a result, it is inevitable to generate some toxic element, toxic gas or toxic ash.

Since PVC is waterproof, moistureproof and non-slip, it is inevitable for some products, such as a beach umbrella or a beach chair, to use PVC as material. For example, although the umbrella cloth or chair back made from PVC are waterproof, moistureproof and non-slip, they may emit gas harmful to the human body due to high temperature caused by strong sunlight. Furthermore, there are still many products, such as a non-slip mat, exercise mat, material for handbag, material for shoe, material for curtain, wall paper and packet are made from PVC.

Besides, some commercially available soft non-slip mat is made from the conventional PVC completely, therefore, it smell bad. Moreover, after burning or undergoing sunshine, it will generate gas harmful to the human body and thus is not suitable for use. However, it is impossible for user to prohibit such the non-slip mat.

Under the above consideration, it is necessary to provide a method for fabricating polymer environmental-friendly resin (PER), which can provide environmental protection, the same effect as conventional PVC and meets the above-mentioned three requirements.

### SUMMARY OF THE INVENTION

Therefore, the main objective of the present invention is to provide a method for fabricating polymer environmental-friendly resin (PER), which can provide the same effect as conventional PVC and does not emit gas harmful to the human body, to replace the PVC made from the conventional method, which may be toxic because of composition of acetic tri butyl citrite.

### DESCRIPTION OF THE PREFERRED EMBODIMENT

The method disclosed by the present invention includes the following steps. First, liquid-phased acetic tri butyl citrite is combined with liquid-phased stabilizer to get the first mixture. Secondly, powder-like poly vinyl chloride, filling agent, light stabilizer uvasorb and fireproof agent are combined together to get the second mixture. Third, the first mixture and the second mixture are combined, and stirred under the room temperature. Finally, a cream-like finished product is gotten.

Then, the cream-like finished product is baked at the temperature of about 170° C. and thus solid-stated polymer environmental-friendly resin (PER) can be available.

The PER has the same effect as the PVC made by the conventional method and therefore is non-slip, waterproof and sun-protective. In addition, the present PER is non-pollution and will not emit the gas harmful to the human body even undergoing burning or sunshine. Even undergoing burning at the high temperature of 1200° C., the present PER merely emit CO₂, H₂O and little amount of chlorine (Cl), even less than the quantity contained in the daily-used piped water. Therefore, the present method can replace the PVC made by the conventional method and be used to fabricate any product made from PVC. The product made by the present method will not emit the gas harmful to the human body even undergoing burning or sunshine, which meets the third item of environmental-friendly requirement of above. Further, this requirement can be proven according to the test reports shown in the attachment 1 and attachment 2.

In sum, the present invention provides a method for fabricating polymer environmental-friendly resin (PER), which provides the same effect as the conventional PVC. Additionally, the product made by the present invention is environmental-friendly and will not emit harmful material or gas even undergoing burning or sunshine. Further, the present method meets the requirement of novelty and thus is patentable.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for fabricating polymer environmental-friendly resin (PER), comprising the steps as follows:
combining acetic tri butyl citrite with stabilizer to get the first mixture;
combining poly vinyl chloride, filling agent, light stabilizer uvasorb and fireproof agent to get the second mixture;
combining and stirring the first mixture and the second mixture at the room temperature to get a cream-like finished product ; and
backing the cream-like finished product at the temperature of about 170° C.

2. A method for fabricating polymer environmental-friendly resin (PER), comprising the steps as follows:
combining liquid-phased acetic tri butyl citrite with liquid-phased stabilizer to get the first mixture;
combining powder-like poly vinyl chloride, powder-like filling agent, powder-like light stabilizer uvasorb and powder-like fireproof agent to get the second mixture;
combining and stirring the first mixture and the second mixture at the room temperature to get a cream-like finished product; and
backing the cream-like finished product at the temperature of about 170° C.
